(19) United States
(12) Patent Application Publication
(10) Pub. No.: US 2002/0099691 A1
(43) Pub. Date: Jul. 25, 2002

(54) METHOD AND APPARATUS FOR AGGREGATION OF DATA IN A DATABASE MANAGEMENT SYSTEM

(76) Inventors: MICHAEL DEAN LORE, KATY, TX (US); EVA MAN-YAN TSE, SUGARLAND, TX (US); JOHN ANDREW DYSART, CYPRESS, TX (US)

Correspondence Address: WILLIAM T RIFKIN, RUDNICK & WOLFE, P O BOX 64807, CHICAGO, IL, 606640807

(21) Appl. No.: 09/109,969

(22) Filed: Jun. 24, 1998

(51) Int. Cl. G06F 7/00

(52) U.S. Cl. 707/2

(57) ABSTRACT

An aggregation engine for a data warehouse which provides an indexing technique which allows the measures in a fact table data entry to be added to the appropriate aggregate bucket by mapping the each of the dimension keys to an aggregate index within a level in that dimension and then calculating an overall index using the aggregate index from each dimension which is then mapped onto the aggregate bucket in question. A rolling cache is also provided allowing frequently or recently used aggregate buckets to be represented in memory rather than in a file, and merged with the equivalent bucket in an aggregate file when necessary, so that the slower access to the address file and the aggregate files can be avoided.

### BACKGROUND OF THE INVENTION

This application describes a methodology to build aggregated data based on transactional data for populating data warehouses or data marts. Aggregated data in data warehouses or data marts is mainly used for decision support for effective business management. An overall background view on problem spaces and data warehouses addressed by the present invention can be found in “The Data Warehouse Toolkit” by Ralph Kimball. John Wiley & Sons, Inc. ISBN 0-471-15337-0.

Pre-aggregation of data is important because it facilitates fast query response time from an OLAP (On-Line Analytical Processing) tool on commonly asked queries. These queries usually require the combination of a large volume of transactional data which is prohibitively expensive to do at the query time. Pre-aggregation also cuts down the overhead if the same query is asked for more than once by a different manager or department.

One of the first steps in building a successful data warehouse is to correctly identify the different dimensions and the fact set within a business structure. This is often known as dimension modeling. Each dimension represents a collection of unique entities that participate in the fact set independent of entities from another dimension. The fact set usually contains transactional data where each transaction (or record) is identified by a combination of entities one from each dimension and contains a number of measures associated with the transaction. The fact set can be represented by a fact table. FIG. 1 shows a star schema for a supermarket business where the star schema is the outcome of the dimension modeling process.

Each dimension can be represented by a table in which each record contains a key (or a composite key) to uniquely identify each entity and a list of attributes to qualify or describe the corresponding entity (or key). Each fact record in the fact table would contain a foreign key to join to each dimension and a list of measures which represents the transactional data. The dimension table could be further normalized, for example in a snowflake schema, but this is not normally done because the size of a dimension is usually much smaller than that of the fact table. Thus, the space saved by normalizing would not be that significant. Also, it is not time-effective for an OLAP query tool to join the normalized dimension tables at query run-time.

Theoretically, an OLAP tool could directly query against a data warehouse containing transactional data in the above star schema layout. However, in order to allow fast response time on high level queries, for instance, a query to get the monthly sales volume of a particular brand product for each state, pre-aggregation of data in a data warehouse is definitely required.

Levels of data are specified in each dimension for aggregation purpose. Each level defines a class of dimension entries with a common degree of summarization. Dimension entries are grouped into different categories within a level based depending on their attributes at that level of summarization. Dimension entries can only fall into one category within a level. For instance, in the store dimension, a level could be specified for each state where the level would contain one aggregated dimension record for each state where it has at least one store in it. In other words, each aggregated dimension record for a particular state would represent the aggregation of all stores that are in that state. Similarly, another city level could be specified in the store dimension to allow the creation of aggregated dimension records where each entry represents the aggregation of all stores in a particular city. It should be noted that the levels do not need to be associated with any particular field or set of fields within a dimension, but can be any grouping desired. A level referred to as the detail level will normally also be defined in which the dimension records are not aggregated, e.g. the store level in the store dimension. It should be noted that the partitioning of the dimension entries into aggregates within a defined level can be completely arbitrary and need not be determined by the attributes of the dimension stored in the dimension table. Likewise, not all dimension entries need form part of an aggregate in a particular level. For example, while a particular store sells very few products and might be required in some high level queries (e.g. a total sales by state query) it might have such little data in other queries (e.g. a product by day by store query) that it is omitted from the store level for convenience.

The aggregation required in the output fact data is specified by combinations of levels, one from each dimension, to be aggregated on. The combination of levels used to specify aggregation is also referred as a cross product of levels. To do a month by brand by state query in the above star schema example, the corresponding level would need to be defined in each of the dimension and specify the aggregation of the transactional data based on the cross product of the three specified levels.

It should be noted that an “all records” level in each dimension will normally be provided which has a single aggregate encompassing all records in that dimension, regardless of the associated dimension key. This level will be used in a cross product for a dimension in which all entries are required. For example, if a state by brand cross-product were required, the state and brand levels would be used for the cross-product in the store and product dimensions respectively and the “all records” level would be used in the period dimension. The “all records” level is not necessary if an architecture is used which allows level cross products to omit levels from certain dimensions. Such an architecture could be used according to the present invention, but the cross products of the preferred embodiments of the invention take a level from each dimension.

If the number of levels defined in each of n dimensions are L₁, L₂. . . Lₙ, then the total number of possible types of aggregations (cross products) generated is L₁,L₂x . . . xLₙ. The actual number of aggregated fact records generated would depend on the number of constituent entries in each of the levels in each dimension.

Users may specify that the aggregates for all the possible cross products of levels in all the dimensions are generated. However, this would normally result in an aggregate explosion problem where the number of aggregates generated ends up being much larger than the original number of fact data records. This is highly undesirable because of space and because users are not always interested in all aggregates from all combinations of levels. Thus, users may also specify a list of cross products to do selective aggregation to fit the needs of some specific high level queries.

One or more aggregation expressions are associated with each input fact measure to be aggregated. Some common aggregation expression includes: max, min, average, sum, count, weighted average, and fill with constant value for aggregated data.

A previous consulting service provided by the present assignee does recognition of the containment relationship between detail dimension records and aggregated dimension records, and aggregation of fact data.

Calculating all the aggregates of all dimensions in one shot is often impossible because of the huge memory requirements to hold all the “aggregate buckets” in the memory at the same time where an aggregate bucket is an internal representation for each aggregated output fact record. The above mentioned service provided by the present assignee performs its aggregation based on a phasing approach wherein the aggregation process is divided into a number of phases. In each phase aggregation is performed on one or more dimensions by sorting and reading the input fact data and the aggregated fact data from the last phase. Thus, the maximum number of phases required is the number of dimensions. This approach minimizes the number of buckets required in the memory at one time.

However, there are disadvantages to the phasing approach. It is not generic enough to be used to generate different combinations of aggregations in different star schema scenarios. To set up an efficient phasing approach, it requires knowledge and expertise of the dimension data and the cross products to be generated so that one could estimate the number of aggregate buckets required by each phase and order the phases based on a system's memory constraint accordingly. Thus, the phasing approach is highly data dependent. In order to achieve phasing, sorting of the input data in between phases is also required, where the files to be sorted could be large because they contain both input and aggregated fact data from the last phase. In other words, phasing also requires multiple reads on the input fact data which is expensive for a large data set.

Another approach for aggregation used by the present assignee's previous consulting service is referred to as “delta memory dumper”. This approach requires the input fact data to be sorted based on one dimension, and also that levels are arranged in a hierarchy, so that categories in lower levels can be combined to form categories in higher levels. The data will need to be sorted based on the grouping of the attribute values of the sorted dimension. All aggregations are performed in one phase. When the sorted attributes in the sorted dimension change, it is known that the aggregates involving these attributes are complete, and these aggregates are dumped out. This approach carries the same memory constraint and sorting requirement as the phasing approach.

Many techniques exist today for the purpose of summarizing data. In general, these techniques A cannot deal with the volume of data and the number of aggregates that need to be created. There are many problems with such techniques including the following:

a) Each aggregate may be the summation of thousands or even millions of records and thus must be computed in a batch or off-line fashion rather than upon demand.

b) The number of aggregates generated for any given dimension is often two to four times the number of detail records.

c) The data explosion from the dimension level is worsened when the aggregation levels are combined across dimensions (based on the level cross-product list).

d) The number of potential aggregates is usually substantially larger than the number that actually occur in the data. This is because the actual occurrences of transactional data across dimensions is sparse; e.g not all stores carry all products or sell each of them every day.

Any system for computing aggregates under these real-world conditions accordingly faces the following challenges:

a) There are more individual aggregates to compute than can be stored in memory.

b) Each aggregate value being computed must be referenced many times in order to compute the total (as opposed to referenced once, written out, and forgotten). This means the aggregate “buckets” into which values are placed must be readily available.

c) The order of the input data cannot always be modified in such a way that only a minimal set of aggregates need be in memory at any given time.

d) Aggregation levels are not always hierarchical (meaning that lower levels don't always add up to higher levels). This means that the aggregation technique cannot rely on being able to sum up higher aggregation levels from lower ones (like a total for each store in Texas adding up to the sum for all stores in Texas).

e) The sparseness of the data makes it difficult to predict the number of aggregates that will need to be generated.

Given a star-schema arrangement of dimension tables and a fact table, the challenge is to create all required aggregates defined in the level cross-product list in an efficient manner.

### SUMMARY OF THE INVENTION

The present invention relates to an aggregation technique which computes aggregates given a fact input file, a cross-product list, and the types of aggregates to compute (SUM, MAX, MIN, etc.). The fact input file generally contains measures to aggregate and keys to dimension tables. This technique is most applicable to computing aggregates for star schema arrangements of data. However, certain aspects of the invention are applicable to other data structures, and the invention is in no way limited to aggregation of such data structures.

In a first aspect, the invention relates to the generation of an indexing scheme wherein relevant aggregate buckets can be quickly accessed for a given transaction, independently of the dimensional attributes of the transaction, so that the transactional data does not need to be sorted prior to aggregation.

Given a key or keys for each dimension table associated with a fact entry, means are provided to produce any of the aggregate keys associated with the levels in that dimension corresponding to that key. These aggregate keys could be represented numerically or in other forms. Means are provided for mapping a set of these aggregate keys from different dimensions, associated with a level cross product between dimensions onto a unique master synthetic key. This key can likewise be represented numerically or in another form.

The indexing scheme of the present invention allows access to aggregate buckets through a sequential and compact index.

In a second aspect, the invention relates to the provision of a memory cache of recently and/or frequently accessed aggregates, whereby to speed up access to these aggregates.

Also according to the invention, aggregates can be moved from the memory to file in intervals instead of every time a value needs to be merged in. This substantially reduces disk access and allows the disk access to be more ordered.

Furthermore, according to the invention, formulas can be provided to allow appropriate aggregates to be kept in memory while allowing others to be in a file cache, whereby to minimize file access.

In a third aspect of the invention, a data structure is provided for mapping the unique master synthetic keys provided for each aggregate combination which might occur onto the much lower number of actual aggregates which do occur. In the specific embodiment of the invention described, this data structure is provided in the form of an address file. The mapping data structure removes the penalty of having high degrees of sparsity in terms of the aggregates that actually occur in the data. Huge volumes of aggregates can be represented and aggregated in an amount of memory that depends only on the number of aggregates to which are actually provided with data. The volume of memory used has no dependence on data ordering or sparsity.

While a preferred embodiment of the invention uses a single unique integer key to identify detail data in each dimension, the technique of the invention could easily be implemented using composite keys or non-integer keys.

The technique of the invention does not actually require the dimension tables (or files), because an earlier step, which is usually trivial, is assumed to have provided information about which detail records are components of which aggregates. The information is provided in the form of relation lists which are used to create the relation tables used by the invention.

A fundamental difference between the aggregation of the present invention, and the phased approaches used previously is that it eliminates the memory constraint. No knowledge is required of the dimension or fact data in order to set up any phasing technique. It automatically takes the benefits of sorted input fact data but does not internally sort the data or require the data to be sorted from input. It also reads the input fact data only once.

While the specific embodiment of the invention described uses a star-schema dimension structure, the invention could easily be employed using other dimension structures such as snow flake schema. As long as a means is provided which maps each identifying key in the fact data onto the aggregates associated with the key, the aggregation technique of the invention can be employed.

### BRIEF DESCRIPTION OF THE DRAWINGS

The invention will hereinafter be described with reference to the following drawings in which:

FIG. 1 shows an example of a star schema data layout for a simple supermarket business.

FIG. 2 shows an aggregation engine according to a specific embodiment of the present invention.

FIG. 3 shows an example of a dimension table according to the preferred embodiment of the invention once it has been updated to include aggregate keys.

FIG. 4 shows an example of a relation list used in creating the dimension tables of the preferred embodiment of the present invention.

FIG. 5 shows the structure of a relation table used by the aggregation engine shown in FIG. 2.

FIG. 6 shows the structure of an index table according to a specific embodiment of the invention.

FIG. 7 is a graph showing the equations used to calculate an MRU (most recently used) factor based on the contents of a history vector, for deciding which records to transfer from a rolling cache according to the present invention.

FIG. 8 is a graph showing a typical distribution of priority values in a cache according to a specific embodiment of the present invention.

FIG. 9 shows a suitable data structure for implementing an address file according to a specific embodiment of the invention.

FIG. 10 shows the format of the nodes of the data structure shown in FIG. 9.

FIG. 11 is a data flow diagram which shows the operations of the system of the specific embodiment of the invention when reading one input fact record and doing all the corresponding aggregations.

FIG. 12 is a data flow diagram which shows the data flow between relation tables and the index table when the system of the specific embodiment maps from input key combinations to all its participating aggregation bucket indexes.

FIG. 13 is a data flow diagram which shows the operations of the system of the specific embodiment when it has finished all aggregations and output the aggregates to an output fact table.

FIG. 14 shows the object containment hierarchy of a presently preferred embodiment of the invention.

FIG. 15 shows a modification of the object containment hierarchy shown in FIG. 14.

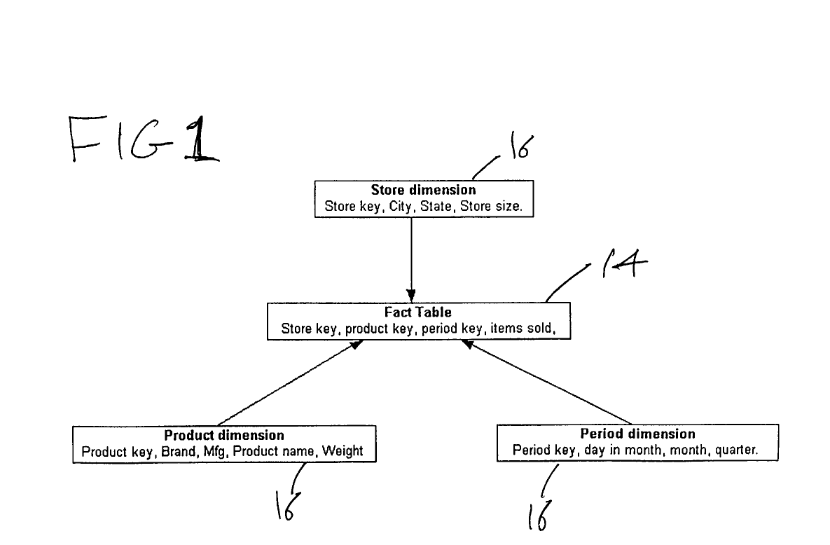

### DETAILED DESCRIPTION OF THE INVENTION

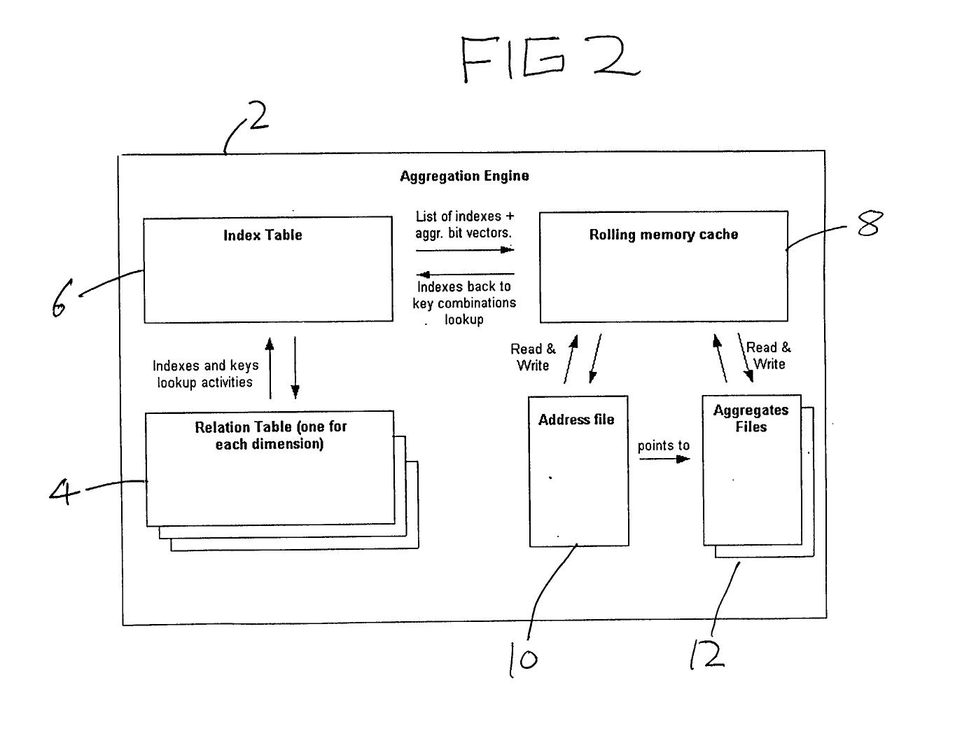

An example of a specific embodiment of the present invention will hereinafter be described with reference to FIG. 2 which shows an aggregation engine according to a presently preferred embodiment of the present invention.

The aggregation engine 2 comprises a set of relation tables 4 for each dimension, an index table 6, a rolling memory cache 8, an address file 10 and one or more aggregation files 12.

The structure of the components of the engine and the interaction of the components will be described along with examples of the operation of the engine.

A fact table 14 contains detail data comprising the measures which are to be aggregated, and a key for each dimension. The keys for each dimension are used to identify the incoming records and map them to the appropriate aggregates. The fact table has the following representation:

| | | | | | | | |
|---|---|---|---|---|---|---|---|
| Key₁ | Key₂ | . . . Key₁ . . . | Key_{N} | Measure₁ | Measure₂ | . . . Measure₁ | Measure_{N} |

The aggregation engine of the specific embodiment can handle any fact table with one or more dimension keys and one or more measures. The columns can be in any order. In the preferred embodiment implementation a flat file is used, but any record-oriented source could be used including a SQL query or ODBC connection, a network stream, or other interface.

There should be one key for each dimension. The keys are best represented as integral numbers because they are faster to compare, but other data types could be chosen. The actual dimension tables and attributes are not required for aggregation.

The measures can be numeric, date, string, or other data types for which aggregations make sense. In general, any type for which functions like Average, Maximum, Count, and Total can be applied can be used.

Any system for computing aggregates must have as input the type of aggregations to perform for each measure. A specific implementation of the aggregation technique supports the following aggregation types (although other types could be incorporated): Minimum, Maximum, Rolling average, Weighted average (involves the column to be averaged and a “weight” column), Total, Count, Fill (places a given value into the aggregate)

Each measure may have several aggregation types applied to it (average and total, for instance). The aggregation types are provided in a simple list of items of the form:

| | | |
|---|---|---|
| Measure column index | Aggregation type | Optional data (weight column |
| | | index or fill value) |

If a measure has more than one aggregation type then its index appears more than once in the list.

Dimension tables 16 contain detail records, each comprising a key for the dimension and attributes corresponding to that key.

The dimension tables 16, as stated earlier, are not required for aggregation. The system requires a relation list 18 which is easily built prior to invoking the aggregation. A relation list defines the aggregates which a record with a specific key in the dimension in question, referred to hereinafter as the detail key are to be aggregated into, and has the following format:

| | | |
|---|---|---|
| Aggregate Level Code | Aggregate Key | Detail Key |

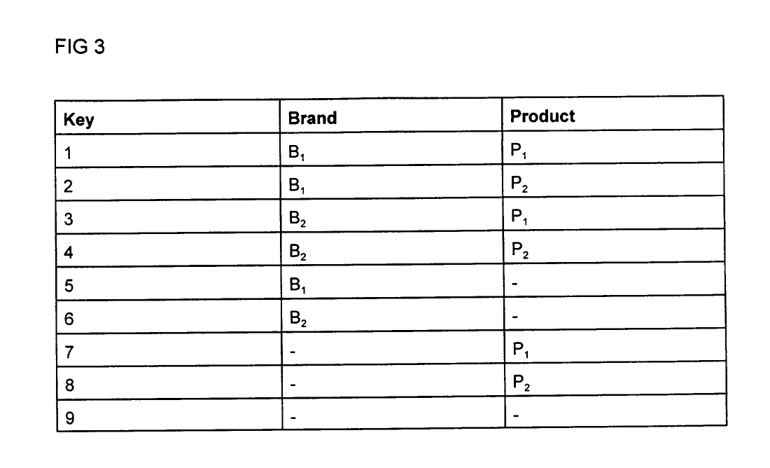

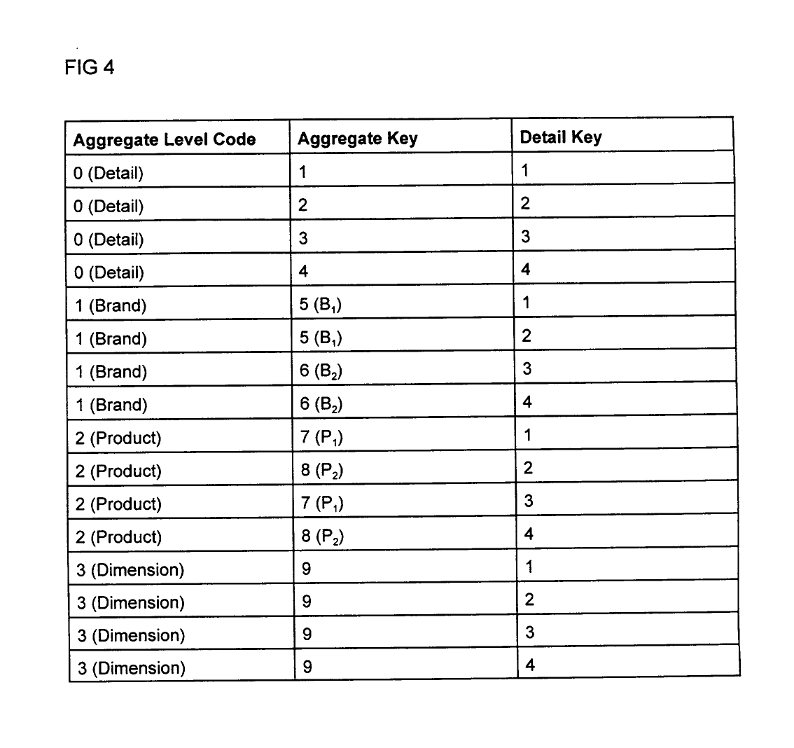

An example of a relation list 18 according to the present invention is shown in FIG. 4, which refers to the dimension table 16 shown in FIG. 3.

The aggregate level code is an arbitrary integral number which identifies the aggregation level, such as the city level in the store dimension of the above example. This could also be represented by another data type, but integers suit the need well.

In this specific embodiment, the aggregate key is a dimension key added to the end of the dimension table 16 that is used to represent that aggregate. When aggregates are identified (like the state-level aggregate for Texas), a record is added to the dimension table to represent that aggregate and it is given a key, as shown in FIG. 3. In this embodiment of the invention, it is assumed that the aggregate records in each dimension have been identified prior to the actual aggregation. The aggregate keys cannot overlap with the detail keys, and in this embodiment are integers following on from the last integer used as a detail key in the dimension in question.

The detail key is just a key for the detail input data (e.g. representing a specific store in the above example) . This key will likely be seen in the fact table one or more times.

Aggregate keys will appear multiple times in the relation list 18 and must always have the same aggregate level code. In this manner, the relation list identifies all of the keys for the detail records that contribute to each aggregate.

The relation list 18 in each dimension is simple to create. The following simple example demonstrates the process. Given the following detail data in a particular dimension, which is also shown in FIG. 3:

| Key | Brand | Product |
|---|---|---|
| 1 | B₁ | P₁ |
| 2 | B₁ | P₂ |
| 3 | B₂ | P₁ |
| 4 | B₂ | P₂ |

If a brand level is required, a record must be created for each unique brand. This is achieved by reading through the detail records and creating a brand record, consisting of the brand and the aggregate key for that brand, whenever a new brand is encountered. For each detail record, a relation record is created in the relation list. (Note that the other fields that are not used to identify the level, i.e., Product in this example, are left empty or NULL for the aggregate records.)

| Key | Brand | Product |
|---|---|---|
| 5 | B₁ | — |
| 6 | B₂ | — |

The following entries are entered in the relation list. These entries show that detail keys 1 and 2 are aggregated to aggregate key 5, and that detail keys 3 and 4 are aggregated to aggregate key 6:

| Aggregate Level Code | Aggregate Key | Detail Key |
|---|---|---|
| 1 (Brand) | 5 (B₁) | 1 |
| 1 (Brand) | 5 (B₁) | 2 |
| 1 (Brand) | 6 (B₂) | 3 |
| 1 (Brand) | 6 (B₂) | 4 |

For a product level, the following aggregate dimension records are created, and added to the dimension table:

| Key | Brand | Product |
|---|---|---|
| 7 | — | P₁ |
| 8 | — | P₂ |

The following records are added to the relation list:

| Aggregate Level Code | Aggregate Key | Detail Key |
|---|---|---|
| 2 (Product) | 7 (P₁) | 1 |
| 2 (Product) | 8 (P₂) | 2 |
| 2 (Product) | 7 (P₁) | 3 |
| 2 (Product) | 8 (P₂) | 4 |

Note that these relation records and aggregate dimension records can be determined for all desired levels with only one pass through the detail records. The relation list would then be sorted by detail key.

It might be the case that a decision is made not to create aggregates for certain attributes in the dimension table in particular levels. This might happen if there is very little fact data with this attribute and the aggregate would be of little use, and would clutter up the aggregated output data. For example, in the above example, a brand with very few sales might not be aggregated. Hence, it is not necessary for all detail records to contribute to all the levels for the dimension in question.

If a dimension will not appear in certain cross products, (for example the period dimension does not appear in a store × product cross product), a dimension level will need to be defined for that dimension, with a single aggregate in which all entries fall. In this case, level 3 is used for this level.

One relation list 18 must be provided for each dimension. A simple mapping must be provided which indicates which relation list corresponds to which dimension key column in the fact table 14. This is as simple as providing the correct column index with the relation list.

In addition, a level code needs to be designated for the detail data associated with this relation list. This is used in the indexing technique and in the level cross-product list to identify detail data, as discussed later.

The relation tables 4 are part of an indexing scheme that is ultimately used to determine a unique sequential index of an aggregate across dimensions. The structure of the relation tables of the specific embodiment of the invention described is shown in FIG. 5. There is one relation table per dimension. The relation table is built from the relation list 16 provided as input and delivers the following information:

a) Given an aggregation level code and aggregation key, the relation table 4 provides the index of that aggregation key within its level.

b) Given a detail key, the relation table provides the index of that detail key.

c) Given an aggregation level code and index, the relation table provides the aggregation key at that index.

d) Given a detail index, the relation table provides the detail key at that index.

e) Given an aggregation level code (or the detail level code), the relation table provides the total number of aggregates at that level and the total number of details used to compute those aggregates.

f) Given a detail key, the relation table provides the list of aggregate keys in which the detail measures must be aggregated.

The relation table 4 is designed to be straight-forward to load and fast to access. It consists of three vectors of three types of nodes:

1) Level Node

| | | | |
|---|---|---|---|
| Aggregate | Total number of detail | Index of first aggregate | Index of last aggregate |
| Level Code | records that contribute to | node for this level (−1 if | node for this level (−2 if |
| | this level (constituent count) | none) | none) |

There is one level node 40 per level. The constituent count is computed as the relation list (which serves as input to the relation table) is read. This will often be the total number of detail records in the dimension, but might be lower if some detail records are omitted from a level as discussed above. The constituent count is used for calculating the frequency ratio for each level cross product, as will be discussed below.

The aggregate nodes 42 discussed below are sorted by aggregate level code and then aggregate key, so the two indexes mark the start and finish of the contiguous aggregate nodes for this level.

2) Aggregate Node

| | |
|---|---|
| Aggregate Key | Pointer to level node for this aggregate |

There is one aggregate node 42 per aggregate key, as aggregate keys only have a single aggregate level code associated with them.

3) Detail Node

| | | | | | |
|---|---|---|---|---|---|
| Detail | Number of | Index of | Index of | Index of | Index of |
| Key | aggregates | aggregate | aggregate | aggregate | aggregate |
| | (N) | node (0) | node (1) | node (i) | node (N − 1) |

There is one detail node 44 per detail key. Each node contains the indexes of the aggregate nodes 42 for which this detail is a constituent. Note that the detail node is variable length; the maximum number of indexes is the number of levels defined for the dimension, which will not be too large, but if a detail record is omitted from a level, for reasons discussed above it will not have an aggregate node for that level. Note that while the data structures are being built, each index is represented as the aggregate key. After all records are loaded from the relation list, these aggregate keys are translated into the appropriate indexes.

The level node vector 46 is a vector of pointers to level nodes. This representation allows the list to be resorted as levels are added without invalidating the pointers to level nodes contained in the aggregate nodes. The level node vector is sorted by aggregate level code.

The aggregate node vector 47 is a vector of aggregate nodes 42. Even with a large number of aggregates this may be represented as a contiguous memory block because a node is small and fixed-size. The aggregate node vector is sorted by aggregate level code and then aggregate key. While the aggregate node vector is being constructed, it will need to be kept sorted. If this imposes a performance penalty then a temporary binary tree should be filled at build time that is then transferred to the aggregate node vector. Using a vector is important at run time because the aggregate nodes 42 can be referenced by index.

The detail node vector 48 is a vector of pointers to detail nodes 44. Pointers are used because the detail nodes are variable size and contain more data than would be advised to place in a contiguous memory block. The detail node vector 48 is sorted by detail key.

The operations of the relation table are readily implemented around the structures just described. All searches described are on the order of a binary search.

A function for getting the index of an aggregate key within its level has the following parameters:

index=GetAggrIndex (aggrLevelCode, aggrKey)

The index of the aggregate key is obtained by first searching the level node vector 46 for a node 40 with the given level code. Then, the subset of aggregate nodes defined by the aggregate node indexes in the level node 40 is searched, which should be a small part of the overall aggregate node vector 47. Subtracting the index of the first aggregate key in the level node from the index of the aggregate key yields the index of the aggregate key within its level.

A function for getting the index of a detail key has the following parameters:

index=GetDetailIndex (detailKey)

The index of the detail key is obtained by searching the detail node vector 48 for the given detail key. The index of the detail node is the index of the detail key.

A function for getting an aggregate key given the index within its level is as follows:

aggrKey=GetAggrKey (aggrLevel, index)

The aggregate key is obtained by first finding the level node 40 for the given aggregate level. Then, the index of the first aggregate (in the level node) added to the given index is the index of the aggregate node in the aggregate node vector that contains the required aggregate key.

A function for getting a detail key given the index has the following parameters:

detailKey=GetDetailKey (index)

The detail node 44 containing the required detail key is simply the detail node at the given index in the detail node vector 48.

A procedure which gets the number of aggregates and detail Constituents in a level is as follows:

GetCounts (aggrLevel, &aggregates, &detailConstituents)

The level node 40 containing the required counts is found by searching the level node vector 46. The detail constituents is a direct data member of the level node and the number of aggregates is obtained by subtracting the first aggregate node index from the last aggregate node index and adding one.

A function for getting the aggregate keys and aggregate level codes for a detail key is as follows:

aggrKeyList=GetAggregateKeys (detailKey)

This function simply finds the required detail node 44 in the detail node vector 48 and exposes the list of indexes to the aggregate node vector 47 that is contained in that detail node. In the presently preferred implementation, a slightly higher level object is returned that can be used to iterate through the list rather than exposing the data structure directly.

The process for loading the relation table structure from the relation list 18 follows hereinafter. The relation list of the specific embodiment described has some properties that are not required but nevertheless affect the loading process. These are:

1) The items in the list are grouped by detail key. All of the aggregate keys for each detail key can then be identified in one go as the detail records are passed through.

2) Detail records are not repeated in the relation list. If detail records could be repeated in the relation list, a repeat immediately following the original, but relating to an aggregate in a different level could never be detected. This might happen for “unclean” detail dimension data in which the detail key occurs more than once, but could easily be avoided by removing such duplicates when creating the relation list. Here is an example of repeated detail data in a relation list:

| Aggregate Level Code | Aggregate Key | Detail Key |
|---|---|---|
| 1 | 17 | 1 |
| 2 | 18 | 1 |
| 1 | 17 | 2 |
| 1 | 17 | 1 |
| 3 | 19 | 1 |

In this example the second set of detail key 1 should take precedence because it occurred more recently. If duplicate detail records are allowed, prior occurrences of the same detail key can be removed by putting in values that could never occur for real data, such as negative values, as follows:

| Aggregate Level Code | Aggregate Key | Detail Key |
|---|---|---|
| −1 | −1 | −1 |
| −1 | −1 | −1 |
| 1 | 17 | 2 |
| 1 | 17 | 1 |
| 3 | 19 | 1 |

It should be stressed that the relation list 18 does not have to contain duplicates and it does not have to be grouped in any way. This will depend on the routines that are used to create the relation list.

If the relation list has no repeated information and is not necessarily grouped, an appropriate process for loading the relation table data structures is shown in the code in Appendix A.

Note that whenever an item is added to one of the vectors, the sorted order of the vector must be maintained. This is easily accomplished with classes available in the Standard Template Library that comes with C++.

Grouping of the detail records in the relation list has a fundamental advantage in that all the records can be loaded for the given detail key and then the required size of the node can be calculated. It is therefore not necessary to use a dynamically allocated array inside the node, and a smaller fixed-size block of memory can be used instead.

Modifications of this approach which help in loading the relation tables are as follows:

a) Relation records from the relation list 18 are batched up into a small list that is for one detail key. Then the detail node is allocated and all the records in the list are processed as shown above.

b) Any zeroed out entries in the relation list are ignored.

The relation table 4 has three primary uses. Firstly, it provides information about the number of aggregate records for each level so that the index table can be populated. Secondly, it computes indexes of detail and aggregate keys that, when combined with the data from the index table, are used to locate the address of the aggregation buckets in the address file and the entries in the memory cache. Thirdly, it provides the list of aggregate records into which a given detail record needs to be aggregated.

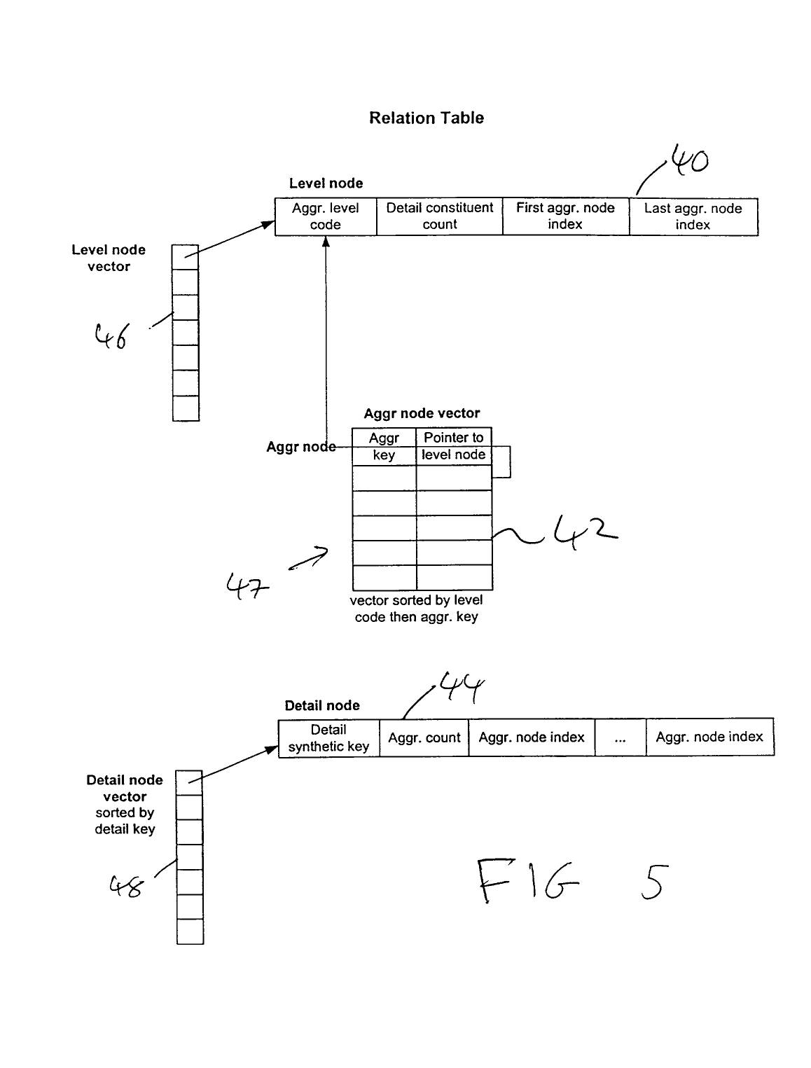

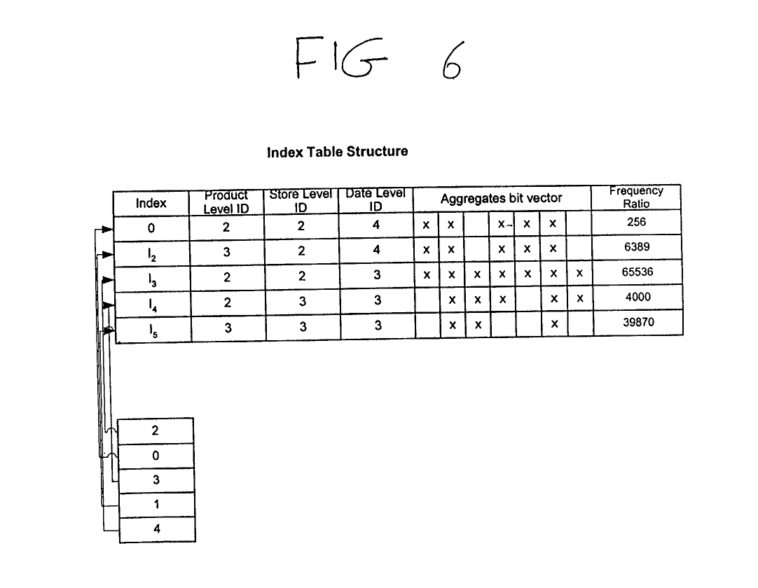

The structure of the index table 6 according to the specific example of the invention is shown in FIG. 6.

A level cross-product list 22 is provided for specifying which level cross products are to be aggregated. The level cross-product list is a list of all of the combinations of levels that should have aggregates computed. In the simplest case (one dimension), this is simply a list of the levels to create aggregates for. The list has a column for each dimension that should correspond to the order of the dimension key columns in the fact table. (This is not a requirement, but makes things simpler if true.) The columns contain aggregate level codes. Each row of the list represents a single cross-product.

The level cross-product list 22 is a way to imagine all dimension tables packed into one giant table. It combines the levels of each dimension into groups which represent the levels defined for the “merged” dimension table. This allows normal aggregate identification to take place while reaping the benefits of the substantially reduced table sizes.

The index table also contains the index where aggregate buckets for each level cross-product begins. The index is computed by multiplying the total number of aggregates for each level in the cross product and adding it to the prior index.

The index table 6 serves as a fast key mapper. Mapping from a dimension key combination to its aggregation buckets is required to locate the bucket in a timely fashion in order to do measure calculation. Mapping back from aggregation bucket location to its key combination is needed when all aggregations have been done and they are ready to be outputted as output fact data. These mappings are very heavily used operations and thus it is important for them to be effective.

The index table 6 is built based on the relation table of each dimension and a list of level cross products to be outputted. The index table is first initialized by the list of level cross products to be outputted. Each level is specified by a unique level identifier from each dimension. The level code is implemented as an integer for fast comparison. Based on the information from the relation tables 4, the index table 6 would know the number of (detail or aggregated) constituent dimension records in each level. With that, the index table would be able to calculate the number of possible aggregates in a particular cross product by doing a multiplication on the number of constituent aggregate dimension records in each level. This number would be accumulated and serve as the starting index of the first aggregate bucket of each corresponding level cross product. Note that the first index of the first level cross product in the index table starts at 0.

The index table 6 also saves frequency information for each level cross product. The frequency ratio info is used to help the calculation of the priority of aggregation buckets when they are ready to be rolled out from the rolling memory cache. Frequency ratio of each cross product is calculated based on the information from relation tables when the index table is created. It is a measure to estimate how likely it is that an input fact record will need to be aggregated into a bucket of the level cross product.

Let n be the number of dimensions, and L, be the number of aggregate buckets in a particular level for dimension i. The frequency of the level cross product L₁, L₂, . . . Lₙ is then calculated as:

(1/L₁)* . . . *(1/L₁)* . . . *(1/Lₙ)

which is the inverse of the total number of possible aggregate products in the cross product. In other words, if a cross product has more aggregate buckets, it implies the likelihood that an input fact record will get aggregated into one particular bucket is lower because these are usually low level aggregates, and therefore a lower frequency ratio is assigned to the cross product. On the other hand, if a cross product has fewer aggregate buckets (e.g. Cross products like: State by Mfg by Year), then the likelihood that an input fact record will get aggregated into one of those buckets is higher because those are usually higher level aggregates, and therefore a higher frequency ration is assigned to the cross product.

When the frequency of each cross product is calculated, the index table 6 would need to determine the highest and the lowest frequency among all the cross products. Then, the frequency ratio of each cross product will be calculated as a certain percentage of an adjustment constant. The adjustment constant is just a number to scale up the percentage to an integral number. In a presently preferred implementation, the adjustment constant is the maximum value that can be held by an unsigned short integer which is 65536. The frequency ratio for each cross product is computed as:

((1/L₁)* . . . *(1/L₁)* . . . *(1/Lₙ)−low_{—}frequency)/(high_{—}frequency - low_{—}frequency)*adjustment_{—}constant.

Where the cross product with the lowest frequency would have the value 0, the cross product with the highest frequency would have the value of the adjustment constant, and the other ones would have a frequency ratio value between 0 and adjustment_constant.

If the value of high_frequency is the same as low_frequency, or if their values are so close that the difference is negligible, then the frequency ratio of all cross products could be assigned as the same adjustment_constant value. This gives all cross products the same frequency ratio.

If there are detail keys that do not contribute to certain levels in the associated dimension (i.e. if there are levels in which the constituent count is less than the size of the dimension), these formulae can be amended as follows:

(Ld₁/(L₁.d₁))* . . . *(Ld₁/(Lᵢ.d₁))* . . . *(Ldₙ/(Lₙ.dₙ))

where Ldᵢ is the number of detail constituents in the same level of dimension i, and d₁ is the total number of detail keys in that dimension.

If less detail keys contribute to a first level in a certain dimension than a second level in the same dimension, proportionately less detail fact data records will generally contribute to aggregate buckets associated with the first level than aggregate buckets associated with the second level. Introducing the Ldᵢ/dᵢ factor takes this into account, but will not affect the original formula in cases where all detail keys contribute to all levels, as Ld₁/dᵢ will be 1 in all cases. For example, consider 100 detail keys in a dimension. A first level has all 100 keys contributing to five aggregate buckets, and a second level only has 60 keys contributing to three buckets. Using the second formula, the factor in the frequency ratio for the dimension in question will be 0.2 in both cases, as both sets of buckets will on average be accessed in 1 out of every 5 fact records.

However, this version of the formula does not in practice make a significant difference to the frequency ratios, because the range of adjustment constants is relatively low, and frequency ratio has a small contribution (20%) to the overall aggregate priority, as will be seen below. The presently preferred embodiment accordingly uses the former formula.

Another augmentation to the index table 6 is that it could save the measures that are required for different output fact data partitions. One output fact set could require certain measures to be aggregated on certain cross products to be different from the measures and cross products required by another fact set. In this case, the index table could also indicate all the aggregates that are required by different output fact sets in different cross products. It could also analyze the aggregates that are actually required by each level cross product and represent it by a bit vector. The engine can determine whether to perform selective aggregation based on the percentage of the aggregates that are actually required over all the aggregates specified by all the level cross products. If the percentage is less than a certain threshold, the engine could perform selective aggregation. In a specific implementation, the threshold is set at 40%.

Note that the entries in the index table 6 are sorted in two different orders: by index and by cross product level combinations. The reason why they might not be in the same order is because optimizing could be done to put the aggregates which are unlikely to be in the cache or are accessed more frequently by the address file in the earlier part of the address file, as there is usually less overhead accessing the items that are at the beginning than at the end of a big file. This will clearly vary depending on the platform being used.

For example, according to a presently preferred implementation, lower level cross products (i.e. cross products that have more buckets but each bucket contains only a few detail entries) are arranged to occupy the later index ranges as they are less likely to be in the cache. Higher level cross products (i.e. cross products that have less buckets but each bucket contains a lot of detail entries) are arranged to occupy the earlier index ranges so that those buckets occupy the earlier part of the address file because they are more likely to be in the cache and therefore generally have to be rolled out from the memory cache more often. The most advantageous storage scheme will clearly depend on the implementation.

The index of an aggregate bucket is computed based on two components: the starting index of the cross product as indicated in the index table 6 and an offset value. Given a key combination and a level code combination, the index table performs a binary search from its list of cross product entries to find the starting index of the specified level code combination. The index table 6 will also need to obtain from each relation table 4 a localized index of the dimension (detail or aggregate) key within the specified level and the total number of keys within the same level. Let Index₁, and Countᵢ be the index and total number of keys in the level of the iₜₕ dimension. The overall index is computed as follows:

Overall Index=(starting index)+Index_{DIM-l}×Count_{DIM-2}×Count_{DIM-i}×. . . ×Count_{DIM-n}+Index_{DIM-2}×Count_{DIM-3}×Count_{DIM-i}×. . . ×Count_{DIM-n}+. . . +Index_{DIM-n}

where n is the total number of dimensions. This produces an overall index known as the master synthetic key which is used to locate the aggregate.

When the aggregates are ready to be outputted to an output fact table, the index or master synthetic key for each aggregate bucket will need to be translated back to its original key value. Given an index value, the index table 6 could do a binary search on the list of starting indexes to locate the cross product combination which the index value belongs to. The index table would then query each relation table 4 for the total no. of keys in each level from the located cross product. The index table then does a reverse computation to get the localized index of the keys in each dimension. The localized index for each dimension can be computed by doing a sequence of divisions by Count_{Dim-n} to Count_{Dim-1}. The quotient after each division (Quotient i-1 for the ith dimension) will be used for further divisions. The remainder of each division with the quotient (Remainder i for the ith dimension) would be the localized index for the corresponding dimension. The formulas are:

| | |
|---|---|
| Quotientₙ₋₁ = Overall index/Count_{Dim-n} | Index_{Dim-n} = Remainderₙ |
| Quotientₙ₋₂ = Quotientₙ₋₁/Count_{Dim-n-1} | Index_{Dim-n-1} = Remainderₙ₋₁ |
| Quotient₀ = Quotient₁/Count_{Dim-1} | Index_{Dim-1} = Remainder₁ |

Note that Quotient₀ will always be zero and the overall index value could be viewed as the Quotientₙ value.

Once the localized indexes are obtained, the index table could query the corresponding relation tables to obtain the actual key values.

One of the big advantages of using the index table 6 is that it allows fast computation of the location of a particular aggregation bucket. Each aggregation bucket is uniquely identified by an integer index value which is easily obtainable by some simple arithmetic operations. Although getting the localized index and the key value from the relation table has an overhead, the overhead is insignificant because those operations are performed only within the specified level which should be very fast. Another advantage of the indexing scheme is that it reduces sparsity in handling the output fact data by computing an index only for those cross products that are to be generated. Cross products that are not required will be eliminated from the index table. It is a common scenario where users do not want to have aggregates for all possible combinations of level cross products. In this case, the address file will only need to handle sparsity problems caused by combinations of aggregates that actually do not occur. By using this selective indexing scheme, the aggregation bucket in the memory does not need to save information relating to all the keys from each dimension. It only needs to save an integer index value. This also eliminates the need to search for the aggregation bucket by doing key value comparisons.

The index table is built with the relation tables of each dimension provided as input and delivers the following major functionalities:

a) Lookuplndexes (inputKeyCombination,&indexesList)

After the engine has read a record from the input fact table, the engine extracts the input detail key combination from the record, passes it to the index table, and looks up all the indexes of the aggregate buckets that the current input fact record needs to participate in. Note that each input fact record can only participate in at most one bucket for each level cross product. Thus, the size of the returned indexesList is at most the same as the number of cross products in the table.

b) LookuplndexesAndAggrs (inputKeyCombination, &indexeslist, &aggrsList)

This function has the same functionality as the first one. In addition, it also looks up the bit vector that indicates the aggregated measures that are needed to be computed for those indexes returned in the IndexesList. This function is used when the engine is performing selective aggregation. The engine will need to determine whether to do selective aggregation or not and, based on that, whether to use the preceding function or this function.

c) GetSynKeysAndLevelCodes(index,&keyCombination, &levelCodeCrossProduct)

Given an index, this function determines the (detail and/or aggregate) key combination that is represented by the index and the level codes for the cross product of the key combination. This function is used when the engine outputs the aggregates to the output fact file. The engine will need to convert the index value of each aggregate bucket back to its key values. The level codes for the cross product will help the engine to determine which fact set that the current aggregate bucket needs to go to because different fact sets could require data from different cross products.

d) aggrs=GetAggrs(index)

Given an index, this function will lookup the bit vector that indicates the aggregated measures that are needed to be computed. The index table would first need to find the corresponding level cross product entry for the specified index using a binary search in its index-ordered entries, then it would return the bit vector for the required aggregate measures. This function is required if the engine is performing selective aggregation and is in the process of rolling out cache entries to the aggregate file. At that time, the engine will need to combine the aggregates in the memory cache with the ones in the aggregate file and will accordingly need to query the index table about the actual aggregates that it needs to combine, as will be discussed later.

e) freqRatio=GetFreqRatio(index)

Given an index, this function will lookup the frequency ration from the index table. The index table would first need to find the corresponding level cross product entry for the specified index using a binary search in its index-ordered entries, then it would return the frequency ratio that is computed when the index table is built. This function is required when the memory cache is full and the engine has to calculate the priority for each entry where frequency ratio is part of the priority calculation formula, as will be discussed later.

In order to handle the huge number of aggregates to be generated, the aggregation engine will need to have an efficient cache to store the aggregation buckets. Storing all the buckets in the memory at the same time would have a huge memory requirement. In addition, it would grow exponentially with the number of dimensions and the number of input fact records. To process more input records would also require more memory. This is definitely not desirable as there is always a limitation on the number of input records the engine could process based on memory constraint. The cache structure in the presently preferred design eliminates the need for an expandable memory size. Three main components are involved in the whole cache structure: the memory cache, the address file, and the aggregate file. The memory cache stores aggregates in memory while the address and aggregate files together store aggregates in temporary files.

The memory cache 8 serves as a store for aggregation buckets that have the highest priority or are most recently used. It is a list of bucket entries, each of which contains: the index of the bucket, a history bit vector, a last input interval count, a priority value, and a list of aggregated measures. The bit vector of length h is used to indicate the hit pattern on the current entry from the last h*g input fact records where g is a granularity constant. If g is 1, the bit vector indicates the exact hit pattern for the last h input fact records. If g is >1, each bit indicates whether there is any hit in that g interval of input fact records. As g value gets bigger, the bit vector would represent the hit pattern of a wider range of input fact records; however, the granularity of the hit pattern would also decrease because a bit is set regardless of whether it has 1 hit or g hits in that interval. This would decrease the accuracy of the priority calculation. In a specific implementation, h and g are set to 32 and 4 respectively. The last input interval count keeps track of the last input fact interval when the hit pattern in the entry is updated. Keeping track of the count avoids the need to update the hit pattern of every entry in the memory cache every time an input fact record is processed. Thus, updates to the hit pattern can be delayed until the priority is calculated or when the entry is being hit. The input interval count is computed as (last input fact record count/g). If g is 1, the count is the same as the last input fact record count. The priority value indicates the priority of the current bucket based on its hit pattern and frequency ratio. The priority is used to determine the records that need to be rolled out when the cache gets full.

The memory cache 8 accepts as input a list of input fact measures, a list of aggregation bucket indexes which the measures will need to be aggregated into, and an optional corresponding list of bit vectors to indicate the aggregated measures required by each bucket index when the engine is performing selective aggregation.

When performing aggregation, the rolling cache would look up the index of the aggregation bucket from the memory cache. If the index is not found and the memory cache is not full, a new entry will be added to the memory cache. In the new entry, all the bits in the history vector are reset to 0 and its rightmost bit is set to 1. The last input interval count is set to the current input fact count/g The measures in the aggregation bucket are calculated as if the current input fact entry is the only entry in the bucket. Although the entry may already exist in the aggregation file 12, its values are not accounted for until the entry is to be rolled out of the cache to the file or when it needs to be merged for output as is described below. The priority value of the entry is left un-initialized because its value is calculated later when the memory cache needs to do a roll out.

The history bit vector and the last input fact count are also updated when an existing cache entry is hit/activated by the current input fact record or when the priority of the entry is to be calculated for the roll out process when the cache 8 is full. The history bit vector is updated by left shifting its bits by (current input fact count/g)−(last input interval count). Its rightmost bit would be set to one if the current cache entry is activated by the current input fact record. It will be left unchanged if it is just the priority value of the entry is being updated. The last input interval count will be set to the value of (current input fact count/g).'

When the memory cache 8 is full, it triggers an update to the priority value of all aggregation buckets in the memory cache. The priority of each bucket is computed based on two main factors: frequency and most recently used (MRU). The frequency ratio of each cross product was calculated and saved in the index table structure. The MRU factor is determined by the history bit pattern up to the current input fact count when the roll out happens. A weighted average of the two factors is calculated as the priority value. In the presently preferred implementation, the frequency ratio contributes 20% to the priority and MRU contributes 80% to the priority. Further experimentation may show that a different value is optimal for this ratio.

To calculate the MRU factor, the history bit vector is divided into three ranges of bits. Each range of bits carries a different percentage weighting in calculating the final MRU factor. The following diagram indicates the ranges and their corresponding percentage in a specific implementation where the length h of the history bit vector is chosen as 32. More efficient values might be found by further experimentation

| Range 3 | Range 2 | Range 1 |
|---|---|---|
| Bits 31 ........................16 | Bits 15 ...........5 | Bits 4 ..0 |
| 15% | 35% | 50% |

Based on the above arrangement, the hitcount ratio is calculated as:

(hitcount (range 1)*0.5/5+hitcount (range 2)*0.35/11+hitcount (range 3)*0.15/16)*32.

Note that the hitcount ratio gives more weight to the most recent range of hits.

The MRU factor is calculated based on two different formulas depending on whether the aggregation bucket is updated by the most recent 5*g input fact records or not, where g is the granularity constant as described before. It is indicated by whether any of the 5 bits in range 1 are set to 1. An adjustment constant value is used in both calculations to scale up the priority into a wider predefined range for comparisons. The adjustment_constant value must be the same value that is used to calculate frequency ratio in the index table 6. In a specific implementation, the adjustment_constant is the largest number that an unsigned short integer could contain.

For buckets that are just updated by the recent input fact records, their priority is calculated based on an inverse exponential curve which has the property of high increasing rate when the bucket is in its first few hits. The formula is:

In(hitcount ratio)/In (32)*adjustment_{—}constant

Note that the hitcount ratio cannot be less than 1 because the history bit count must have at least one bit set in range 1. Thus, In (hitcount ratio) would never generate a negative value.

For buckets that are not updated by the recent input fact records, their priority is calculated based on an exponential curve which has the property of generating low priority for buckets that have low hit counts. The formula is:

exp(In (adjustment_{—}constant)*hitcount ratio/32)

Note that if the hitcount ratio is 0, then this formula would generate a value of 1, which is the lowest possible value for the MRU factor calculation.

The curves of the MRU calculations are depicted in the graph shown in FIG. 7. It indicates the advantageous properties of the MRU factor where it generates much higher priority for the entries that are most recently used and much lower priority for entries that are not recently used. These formulas are chosen to model the life-cycle of the aggregates during aggregation. The reason that two different curves are used is to better distinguish between the entries that are very likely to be needed again after the roll out (i.e., the ones that just got used in the last hits) and the ones that are unlikely to be needed again.

In calculating the priority, it is always desirable to put a heavier weight on the MRU factor because it tracks the current pattern of cache entries utilization. It works particularly well when the input fact data are grouped based on the attributes of one dominant dimension. If the input data are grouped, the aggregate buckets that represent aggregates depending on those particular attribute values will be instantiated when an input record of those particular attributes is first seen. Once that particular attribute value is passed, the buckets will never be needed in the memory cache again, and should be rolled out. Once the number of bits in range 1 is zero, the MRU factor will very quickly become low, and the entry will be rolled out without having to wait for the whole history bit vector to empty.

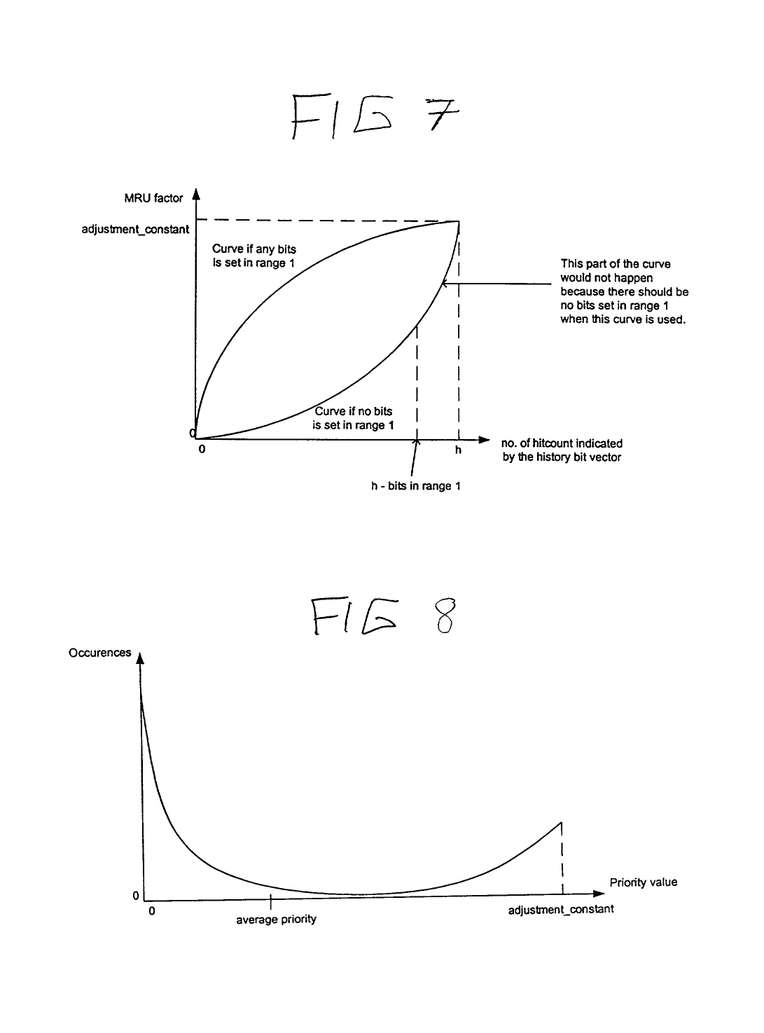

In a specific implementation, the MRU factor is combined with the frequency ratio to obtain the priority based on a 80%:20% distribution respectively. The curve shown in FIG. 8 indicates a typical distribution of the priority value across all the entries in the cache based on a specific implementation with grouped input fact data.

The priority curve shown in FIG. 8 is similar to an inverted bell shape curve. This is a desirable effect of having two different curves in calculating the MRU factor. When there are very few entries that have the middle range of the priority, it is clear cut to determine which entries should stay in the cache and which should not.

The average priority (i.e., 50%) is chosen to be the default cutting percentage for determining whether an entry should be staying in the memory cache during a roll out. Users may also adjust the priority cutting percentage relative the average priority. The appropriate priority cutting percentage may be selected based on the nature of the aggregates to be generated. Decreasing the priority cutting percentage means to keep more aggregates in memory and roll out less aggregates to the disk cache. This is useful if users have a lot of high-level aggregates and they want to keep the aggregates in memory longer because they are more frequently used. Increasing the priority cutting percentage means to roll out more aggregates to the disk cache and keep less in the memory. This is useful if there are a lot of low-level aggregates that might be being held in the memory much longer than they are needed.

Other formulas could clearly be used to determine which entries are rolled out from the cache. Particularly advantageous formulas could be found by further experimentation.

After the priorities are updated, the memory cache 8 rolls out the low priority entries. The simplest way to roll out the low priority entries is to sort the entries on priority values and then roll out the selected percentage of entries. However, this is very inefficient. According to the invention, a calculation is performed to estimate the entries which should be rolled out.

In a first implementation of this technique, to roll out p% of the cache, the cache is traversed and the entries are rolled out with priority=lowest priority+(highest priority−lowest priority)*p%. In the process of rolling out, if the number of rolled out entries equals p% of the cache before hitting the end of the cache, the rolling out of the cache would stop at that point. If the number of rolled out entries is significantly less than p% of the cache, that is, all entries are at the same high priority range. Then, the cache would be traversed one more time to roll out as many entries as necessary to get to p%. Although this is not as accurate as sorting the cache entries by priority and then rolling out the lowest p%, it is acceptable to do the estimation rather doing an expensive sort. An advantageous value for the roll out percentage has been found to be 80%.

In a second implementation of this technique, a low_range% to high_range% of the cache entries will be rolled out. In order to avoid sorting the big memory cache 8 based on the priority values, a calculation is performed to estimate the entries that should be rolled out.

Let p% be the priority cutting percentage that the users have specified. If p%<50%, then the priority cutting point is calculated as average_priority*(p/50); if p%>50%, the priority cutting point is calculated as average_priority+(adjustment_constant−average_priority)*(p-50)/50; if p%=50%, the priority cutting point is the average_priority. In the process of rolling out, if the number of rolled out entries equals high_range% of the total no. of entries before hitting the end of the memory cache 8, then the roll out process would stop. If the number of rolled out entries is less than low_range% after traversing the whole cache, that is, all entries are around the same high priority range, then the cache would be traversed one more time to roll out as many entries as necessary to get the cache size to the low_range%. A certain percentage of the aggregates in the memory cache will always need to be rolled out in order to take advantage of the rolling cache design so that new or other existing aggregates will have a chance to go into the memory cache. Ideally, the priority cutting percentage should be adjusted so that the number of aggregates being rolled out always falls in between low_range and high_range percentage automatically because that would take the maximum benefit of the priority calculation and selection policy described above. In a specific implementation, the low_range and high_range are set to 50% and 90% respectively.' Although it is not as accurate as sorting the cache, its effect is minimized by allowing to roll out a range of cache entries rather than a specific percentage of entries.

To roll out an entry means to find the corresponding entry in the aggregation file 12 if there is one and combine the values in the cache entry with the ones in the file. If the entry is not found in the file, then the entry will be appended to the end of the aggregation file and its file address will be updated in the address file 10. After the entry is rolled out, its entry in the cache is made available for another aggregation bucket. The cache keeps a pool of entries that are allocated when the cache is created, it could mark the cache entry as used when it is part of the cache. It could also keep track of a list of cache entries that are unused so as to recycle the entries after roll out.

Rolling out entries could have a lot of over head because disk I/Os are significantly slower than memory I/Os. A lot of time, the CPU could be blocked waiting for disk I/O operations completion. In an advantageous development of the embodiment, in order to fully utilize the CPU cycles during the roll out process, the memory cache spawns a new thread to roll out the entries once it determines which entries are to be rolled out. The memory cache can then make use of the CPU cycles to do additional in-memory aggregations while the rolling thread is blocked on disk I/O. The memory cache needs to pass a list of cache entries to be rolled out to the rolling thread and the rolling thread is responsible for putting back the finished cache entries into memory cache's entries pool so that they can be reused.

The above configuration can be achieved without using additional memory resources. As the memory cache determines which entries are to be rolled out, it chains the entries into a linked list. Some information (like history bit vector, last input interval count and priority) in an entry is useless once the it has been determined that the entry is to be rolled out. Thus, the memory cache makes use of the unused memory space inside the entry and converts it to a pointer to the next cache entry to be rolled out. There is no memory overhead in building such a linked list while the resources required to build another vector to contain the roll out entries could be more extensive than what it could save in spawning a new thread for rolling out.

The coordination between the memory cache and the rolling thread are achieved by the cache entries pool. The pool is a thread-safe object to be shared by the memory cache and the rolling thread. When the rolling thread has rolled out an entry, it puts it back into the pool. Likewise, when the memory cache needs to add an entry, it gets it from the pool. If the pool is empty, the memory cache will have to wait or yield for an interval of time so that the rolling thread would have a chance to roll out more entries and put them back into the pool. Thus, it is always the case that rolling thread will be finished before the memory cache gets full and needs another roll out. The coordination overhead is minimal considering the CPU cycles that can be saved by overlapping the roll out.

The memory cache 8 is sorted based on the index value. It could be implemented as a binary tree where binary search could be performed based on the integer index value to locate a particular aggregation bucket. The ordering may also be achieved by a hash table. However, there doesn't seem to be a perfect hash function to effectively map the indexes because indexes appearing in the cache might be in no particular pattern depending on how the input fact data is ordered. Thus, using a hash table may risk the overhead of having a long linked list to search anyway.

One of the big advantages of the cache is the concept of the rolling cache. It allows the cache to perform aggregation based only on the input fact records that an aggregation entry has seen so far in its life time in the memory cache. In other words, the cache allows partial aggregation. When the cache is full, the operations of fetching the aggregation file entry, combining the measures from the memory and file entries, and writing the combined results back to the file could be performed together at the same file location. This eliminates an additional file seek that is required if the operations of fetching and writing the cache are not together. The latter is the case if the aggregation file entry needs to be loaded into the cache before doing aggregation (i.e., not doing partial aggregation.)

Overlapping roll out with the continued process of in memory aggregation also minimizes the effect of having to roll out a lot of aggregates. It increases the usage of the otherwise wasted CPU cycles during the roll out.

Rolling out large amounts of the cache 8 at one time also frees up a big percentage of the cache to do other aggregations. This approach is better than rolling out an entry one at a time because the current approach doesn't need to keep track of the priority of each entry at all times which would require updating the history of all entries after doing the required aggregations for each input fact record which is clearly inefficient.

Another advantage of the memory cache is that it is of fixed size. Thus, users may specify a desirable cache size based on the memory available in the system. The memory cache will then compute the maximum number of cache entries that it could contain.

The indexing scheme used by the aggregation technique of this specific embodiment generates an index for each and every possible aggregate identified by the level cross-product list.

Each index takes into account a particular aggregate key from each dimension. All of the indexes are sequential, so there are no gaps.

If each and every possible aggregate occurred in the detail data found in the fact table 14, then every index would be used. In reality, the fact table contains sparse data because not all combinations of data occur. For instance, not all stores sell the same products; even if they did, not would not necessarily sell at least one of every product each day. Thus, cross products like Store×Product×Day may have only 50% of the possible combinations coming in from the fact table. The actual percentage depends on the relationships between the dimensions. (Note that sparse data is usually normal, but extremely sparse data can result from improperly designed dimensions.)

As a simple example, take a scenario with ten stores, ten products, and ten days. If all products sold in each store on each day, there would be 10×10×10=1000 fact table records. If each store sold any 5 of the 10 products each day, there would be 10×5×10=500 fact table records. The following table shows the scenario:

| Aggregation | 10 × 10 × 10 Scenario | 10 × 5 × 10 Scenario |
|---|---|---|
| Level | Number of occurrences | Number of occurrences |
| Detail | 1000 | 500 |
| Store × Day | 100 | 100 |
| Product × Day | 100 | 50 |
| Day | 10 | 10 |
| Store × Product | 100 | At least 50, at most 100 |
| Product | 10 | At least 5, at most 10 |
| Total | 1320 | At least 715, at most 770 |

Note that in some cases, there are “at least” that many occurrences because any 5 products sold each day, meaning all 10 could be represented somewhere in the data, but not on the same day.

The indexing technique for this sample would generate 1320 indexes regardless of how many occurrences actually existed. The implication of this for optimal performance is that the relation list 18 provided should not contain detail keys that will never occur, so that levels will not have superfluous aggregates associated therewith.

The aggregation file contains the actual data “buckets” in which aggregation occurs. The measures are aggregated into these buckets based on the aggregation type (MIN, MAX, SUM, etc.). The size of an aggregation bucket depends on the number of measures and the number of aggregation types to be performed on those measures. Therefore, it could be prohibitively expensive (in terms of storage resources) to allow the aggregate file 12 to be only 50% full. In many scenarios only 10% of the potential cross-product combinations might actually exist, and depending on the data, the sparsity could have extremely low values. For example, samples of data have been found with sparsity of 0.001%..

The address file 10 solves this problem by keeping the address (or rather, the index) of the aggregation bucket in the aggregate file 12 at the position given by the described indexing technique. The address file can afford to be sparse because each address is very small, e.g. 4 bytes per address. If the address file were 2 gigabytes there would be room for 536,870,912 addresses of aggregate buckets. If 20% of the aggregates actually occurred, there would be 107,374,182 aggregates.

A first implementation of the address file 10 according to the invention is used like a big random-access array that is implemented on-disk. On many systems it is best implemented as a memory-mapped file. The specific implementation is chosen by analyzing the performance characteristics or other abilities of the target host computer.

Every value in the address file 10 is logically initialized with an invalid address (−1). To save time, the file is partitioned into multiple sections. These entire sections are initialized the first time any address in the section needs to be set. A list of sections is maintained to track initialization. Each item in the list conceptually contains the index range of the section and a boolean value to indicate whether it has been initialized.

When an address needs to be retrieved from an uninitialized section, the invalid address can immediately be returned. The first time an address needs to be assigned, the section is initialized. When all sections have been initialized a flag indicates that the initialization list is no longer needed. The number of partitions can be tuned in the implementation. The benefit of the approach is that entire sections could be skipped if all the values in the range are not used. In addition, it allows parts of the file to be initialized while the file pointer (or map pages in the case of memory-mapped files) needs to be moved to that location anyway. This reduces the amount of disk access.

While the above implementation of the address file works adequately when sparsity is of the order of several percent, data warehouses can, in some cases, be extremely sparsely populated. When the data is less than one percent populated, the range of master synthetic keys (or “master indexes”) used to locate aggregate buckets becomes extremely large. Although the master indexes are sequential, so few dimension key combinations actually occur that thousands or even hundreds of thousands of master indexes are unused.

Sparsity results from two factors. As has been mentioned, not all combinations of dimension table keys will occur in the fact table. Additionally, dimension table records that are not referenced anywhere in the fact table must still be accounted for in the master indexes (because the relation lists are typically generated before the fact table has been used). Users may opt to clean up the dimension tables, but doing so is time-consuming and sometimes difficult.

Sections could also be assigned by dimension. The user could select the dimension causing the sparseness (like product) so that unsold products in a given range might never need to be initialized or used.

In the presently preferred implementation, sections are assigned along multiples of 4 kilobyte blocks in the file. This means a section has room for 1,024 addresses. A bit vector is used to track whether a section has been initialized. A 2 gigabyte address file has 524,288 sections which can be tracked in a 64 kilobyte bit vector.

A function for getting the address of an aggregate has the following format:

address=GetAddress(index)

To get an address from the address file 10, the given index is first divided by 1024 to obtain the number of the section. Using this number, the bit vector is checked to see if the section has been initialized. If it has, a search to the location index×4 is performed and the value read, which is the address. If the section has not been initialized, a value is simply returned to indicate an invalid (or uninitialized) address.

A procedure for storing an address according to this embodiment has the following format:

StoreAddress(index, address)

To store an address the index is first divided by 1024 to get the section number. The section number in the bit vector is then used to check if the section has been initialized. If it has, the memory location index×4 is located and the address is assigned there. If it hasn't, the entire section is initialized with invalid address values and the given address is assigned to the location index×4 when that location is reached. The bit in the bit vector is then marked to indicate that the section has been initialized.

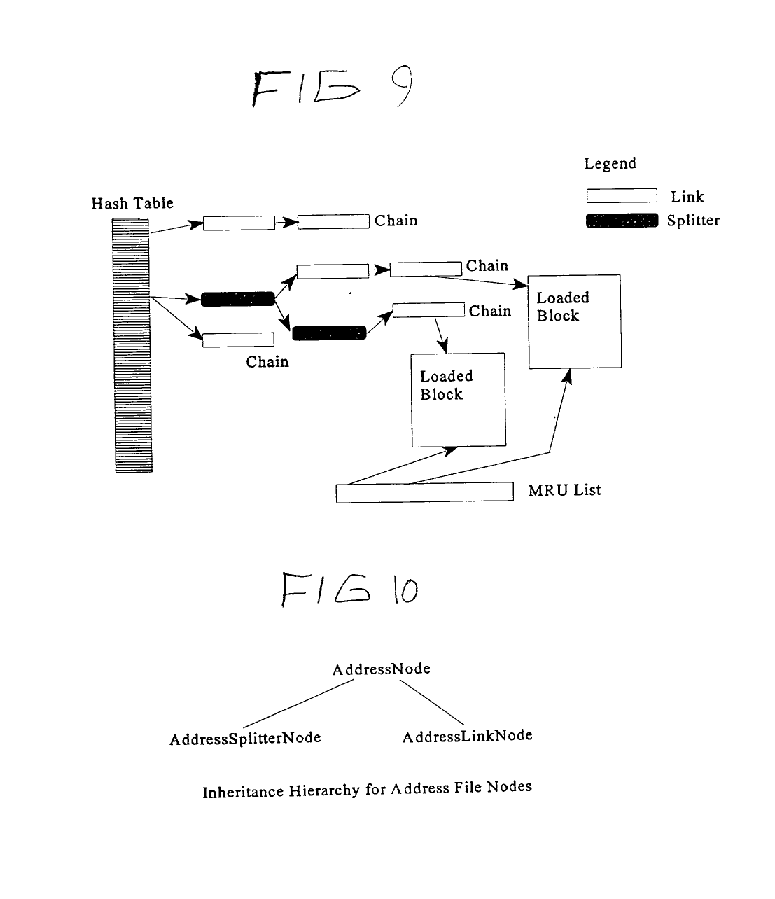

An alternative implementation of the address file works better in situations with very high sparsity, but works equally well for sparsely or heavily populated data. The approach uses a hash table to locate blocks of disk (that are cached in memory) that contain sorted master indexes and the aggregate file locations that are needed. In order to deal with unusually heavily populated hash locations, a given hash location can be split into different ranges using a binary tree. FIG. 9 depicts the data structure.

The size of the hash table is configurable. The optimal size is a function of how many master indexes will be stored; for example, 2000 entries works well in many cases. The hash values are computed by dividing the master index by a value that will yield as many hash values as the table can hold. The number of aggregates, which is also the largest possible master index, is given to the address file upon creation. Alternative hash functions which improve the scattering of entries when patterns are present in the used master synthetic index entries could clearly be used depending on the implementation.

The hash table holds nodes of type AddressNode or subclasses thereof. AddressNode is actually an abstract class that defines the basic interfaces needed for all nodes. This relationship is shown in FIG. 10.

The AddressLinkNode is a normal node that points to the block of addresses (whether in memory or on disk). The AddressSplitterNode is inserted when there are too many addresses at that table location, so that the range of values is split in two. This is like expanding the hash table at that location only.

The address blocks hold as many address records as fit into the block size, which is 16 K. bytes in the presently preferred implementation. Address records have the following layout:

| | | |
|---|---|---|
| Master Index | Index of Aggregate Record | Index of Aggregate Stream |

The master index serves as a key. The index of the aggregate record is used to locate the aggregate bucket in the aggregate file, while the index of the aggregate stream is used to locate which physical aggregate file the bucket is in.

Address blocks have the following layout:

| | | | |
|---|---|---|---|
| | | Address | Pad to |
| Address Record 1 | ...Address Record i... | Record N | 16K Bytes |

They are basically arrays of address records, plus a filler to make an even 16 K. Using an even 16 K. allows many operating systems to handle the disk access better. Other sizes could clearly be used on other operating systems. The address records within an address block are always kept sorted in ascending order by the master index. Additionally, address blocks do not need to be full. The number of entries is kept in another data structure (to be described below).

The primary reason why this version of the address file handles sparsity better than the earlier described approach is because the master indexes are not contiguous in the file. The address block holds those addresses that have occurred for the given hash value. Thus, addresses that do not occur occupy no space in the file.

In order to keep track of the disk blocks an address link node (of type AddressLinkNode) is used. The layout of this node is:

| | | | | | | |
|---|---|---|---|---|---|---|
| Next | Block | First | Last | Address | Modified | Pointer to |
| Address | Address | Master | Master | Record | Flag | Address |
| Node | | Index | Index | Count | | Block |
| Pointer | | | | | | |

The links are part of a linked list (referred to as a “chain” of nodes). When the current address block for a given hash value runs out of space, a new address block is created and is managed by a new address link node. The new node is always first in the chain. The block address is the location of the block in the file. The first master index is the first master index contained in the block, and the last master index is the last master index in the block. (When searching for an address record, these values can be used to avoid loading blocks from disk that could not possibly contain the requested address record.) The address record count keeps track of how many records are in the address block. The modified flag indicates whether the block (when in memory) has been changed and would need to be written to disk. The pointer to the address block is NULL unless the block is currently loaded into a memory region, in which case the pointer points to it.

In general, each hash table entry points to a chain of AddressLinkNode objects that manage the address blocks for the hash value for that entry. The blocks may have overlapping ranges of master indexes, but no duplicates. The address file also has an MRU list to keep track of address blocks that are loaded into memory. The MRU list grows as the address file size grows up to a user-specified limit. The MRU list is a linked list of pointers to AddressNode objects, each of which must have a loaded address block during the duration that it is in the MRU list.

To find a given address record, the hash value is first computed. If the hash entry contains that pointer that is not NULL, then the chain of AddressLinkNodes is searched. The blocks that are already loaded are inspected first, followed by those that must be loaded. Before an address block is inspected, however, the address link node's range of master indexes is inspected to make sure that it could contain the requested address. Address blocks are searched using a binary search algorithm.

In order to maintain good performance, address blocks along a single chain cannot be allowed to have too many overlapping ranges. When that occurs, all blocks end up being searched almost every time that given hash value is touched. The address file automatically detects chains that have too many overlapping blocks whenever a search on that chain is done. A variety of simple formulas can be used to determine what constitutes “too many.” In addition, chains that are “too long” are detected.

When such a chain has been identified during a search, the chain will be “split.” To split a chain, the address blocks for the chain are loaded into memory. New blocks are created that, instead of simply being individually sorted, are sorted across the whole chain. The sort is a merge sort using the values from the old blocks. When the sort is complete, the old blocks are discarded.

When the sort is complete, an address node of type AddressSplitterNode is inserted at the midpoint of the blocks. Address splitter nodes have the following layout:

| | | |
|---|---|---|
| | | Split Point |
| Left AddressNode Pointer | Right AddressNode Pointer | (Master Index) |

The left and right address node pointers point to either a chain of AddressLinkNodes or another AddressSplitterNode. The split point is the first value of the address nodes to the right; it is used to determine how to traverse the binary tree of splitter nodes.

The address splitter node is inserted where the chain of address nodes used to be. The left side contains half of the previous chain, and the right side contains the other half. Additional splitter nodes may be inserted as things progress, but only where a chain is.

The technique of building a binary tree for a given hash value has many benefits. In many cases certain ranges of master indexes are much more dense than others. This technique allows the hash table to expand at the given hash value into several sub-ranges, each identified by the splitter nodes. In most cases, the benefits of a fast hash table are still derived.

The MRU list reduces the disk access substantially, especially when address records are used in a pattern (which is often the case because of how memory cache roll-outs occur). Link nodes maintain the range of a block, further reducing the need to load when an out-of-range address record is requested. Link nodes also maintain whether the block was modified, so that unchanged blocks do not need to be re-written to disk. Preliminary testing reveals that the address file performs almost identically given sparse or dense data.

The address file 10 is used to locate aggregate buckets in the aggregate file 12. As mentioned, the address file can afford to be a little bit sparse.

It should be noted that while this implementation of the address file is considered the most advantageous implementation at the present time, other embodiments are envisaged in which the overall index or location in the address file is established using addressing techniques, rather than mathematically combining the cross product index and an aggregate index within the cross product. For example, each cross product could be provided with a pointer to a starting point of a set of address entries stored in memory. Any method of addressing the aggregates associated with selected cross products could be used, and would be within the coverage of this invention.

The aggregate file 12 is the master storage that holds the aggregates while they are being generated. The file is accessed via a memory cache 8. If the number of aggregates to be generated fits into the memory cache, then the aggregate file will never be used.

The aggregate file 12 is a sequential storage of records that are identical in form to the records stored in the memory cache. The actual location at which a particular aggregate “bucket” is stored depends on the address stored in the address file 10. The first time a particular aggregate is used, it gets the next available position in the aggregate file and that value is written to the address file 10.

An MRU list, consisting of a set of recently used aggregates is also stored in memory to reduce disk activity. The MRU list is of a configurable maximum size and contains 16 K. blocks. The size of an aggregate bucket is variable, so the number of aggregates per block varies. The blocks loaded from and written to the file contain a contiguous set of aggregates taken from predetermined 16 K. sections of the aggregate file. Because memory cache roll-outs happen in a pattern (in order of the master index), the aggregate file tends to be accessed in a pattern that makes good use of the recently used blocks in memory. Anytime a block is removed from the MRU list it must be written to disk.

The MRU list has one special block called the tail block, that is several times larger than an average block. The tail block is filled up and then written to disk in one large write. After being written, whenever aggregates that were contained in the tail block are required, the aggregate is loaded and re-written as smaller 16 K. blocks in the normal part of the MRU list. The tail block reduces seeks to the very end of the file and back to other locations because it takes a while to fill up. Since all new aggregate buckets are written to the end of the file, the tail block improves performance by reducing the number of disk seeks.

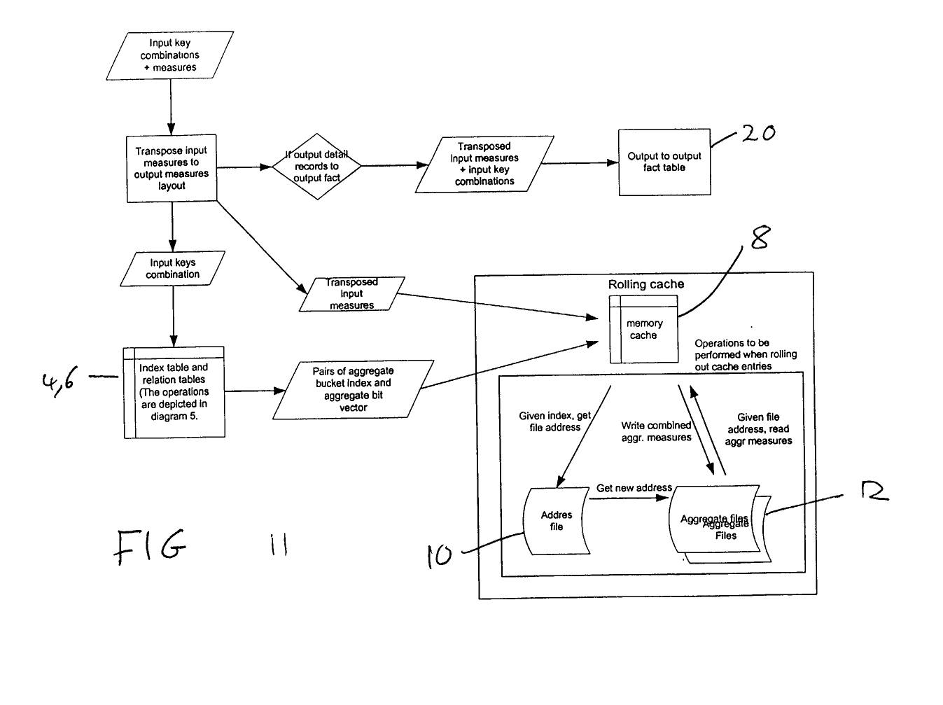

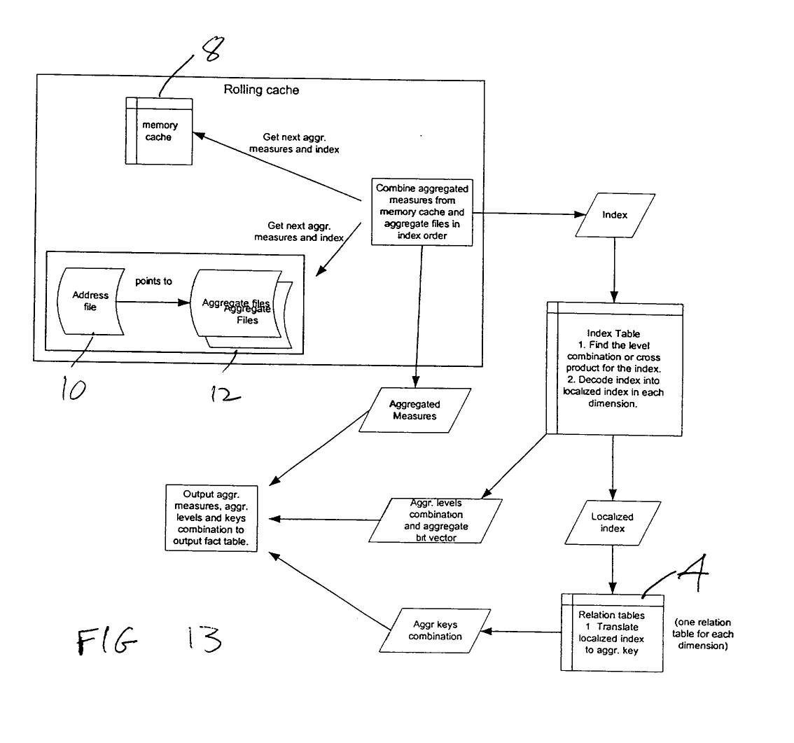

The operation of all the components of the above system will now be described with reference to FIGS. 11, 12, and 13. The system could be viewed as doing two main operations:

1) read input fact record and do aggregations

2) output aggregated records to output fact table when aggregations are done.

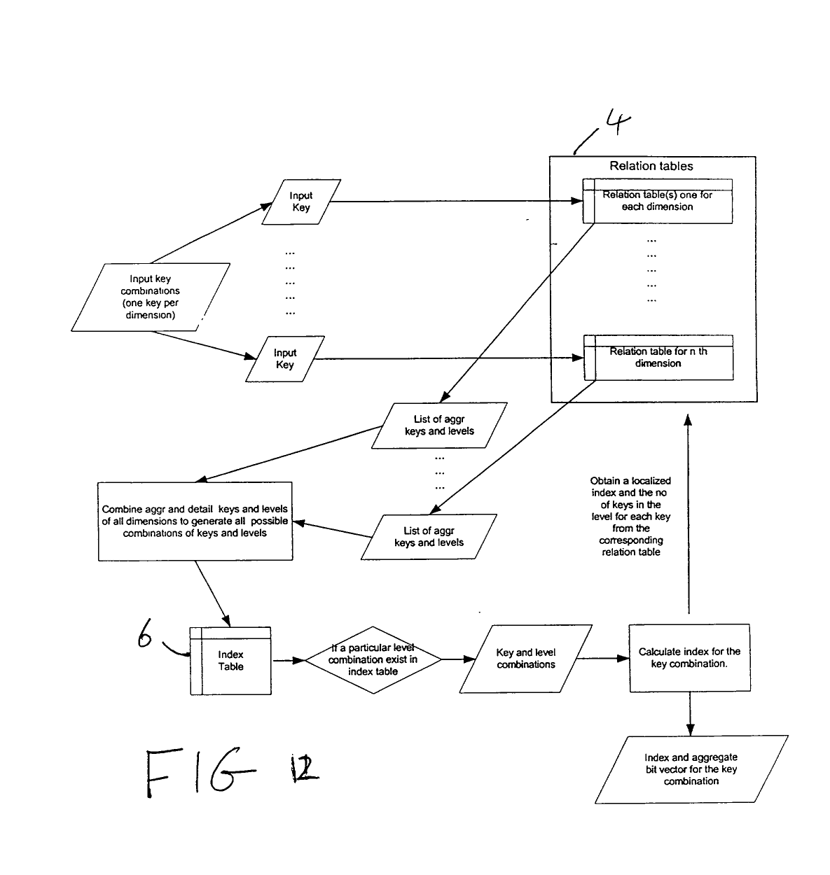

FIGS. 11 and 12 describe the operation of reading one input fact record and doing all the associated aggregations.

When an input fact record is read into the aggregation engine, its measures are first transposed into the same order as interpreted by the aggregate bit vector in the index table 6. For aggregation expressions like min, max, sum and average, the original measure is directly copied to the corresponding output measure(s). For a count aggregation expression, a value 1 is replaced for the original measure value. For a fill with constant value aggregation expression, the original measure value is directly copied for detail data, but for aggregate level data, the system could be optimized to ignore doing the aggregation in the process and treat it as a special case because the operation is basically replacing the measure value with a constant value for all aggregate records.

If outputting of detail level data is required, the input keys and the transposed list of measures will be directly outputted to the output fact set without going into the memory cache 8.

As shown in FIG. 12, each component of the input key is fed into the corresponding relation table 4. The table would then output a list of aggregate keys and levels which the input key would participate in. The system would combine the list of keys and levels obtained from each relation table to get a list of all possible combinations of keys and levels. It would check the list of level combinations against the index table 6. If a level combination or level cross product does not exist in the index table, that means no aggregations are needed to be performed and its corresponding aggregate key combination will be ignored. If a level combination is found in the index table, the aggregate key combination will be mapped into an aggregation bucket index value and an aggregate bit vector indicating the aggregates which need to be calculated. Methods other than a list are clearly possible for mapping the input keys to all the associated aggregates; for example, the level combinations could be looped through in the order that they are stored in the index table and never actually be stored in a list.

The list of indexes and aggregate bit vectors together with the transposed input measures will then be transferred to the rolling memory cache 8 to do aggregations. The rolling memory cache 8 will search to see if the indexed entry is in the memory 8 already. If so, it would combine the memory cache entry with the input measures. If not, it will either use a new cache entry or it may need to roll out the cache first if the cache is already full, as described above.

When all the aggregations are done, the system will obtain aggregates back from the memory cache. The following data flow diagram indicates the operations required for outputting aggregates. The memory cache basically combines the aggregates in memory and the aggregates in the aggregate file 12 in index order. It merges the entries from the memory and from the file as it outputs the aggregates. Note that if the aggregate or address files are never instantiated because the memory cache is big enough to hold all the aggregates, then the merge operation is a no-op. Once an aggregate entry (i.e., aggregate measures and index) is obtained from the memory cache, the index table would then be queried to translate the index into the associated aggregate keys and aggregate levels. This operation is described above. After the index is mapped, the system will then be able to output the aggregated measures and the aggregate keys to the output fact table.

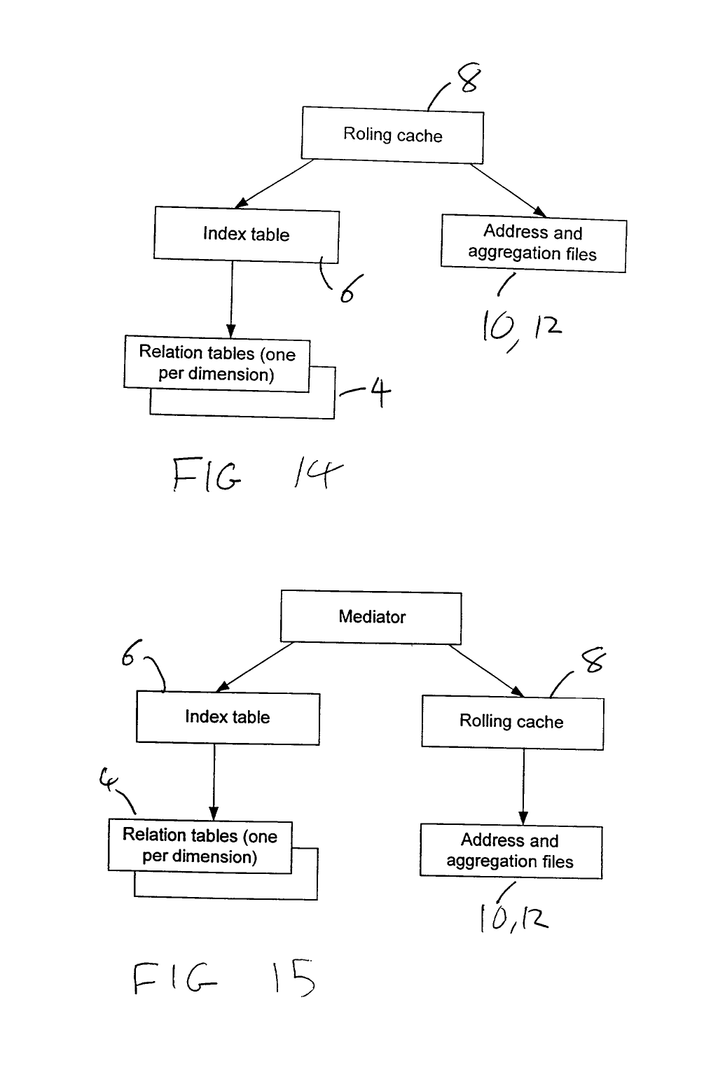

In doing object oriented design and implementation, the containment hierarchy for the four main components is structured as shown in FIG. 14 in the presently preferred implementation.

Note that the lifetime of each of the lower level objects is shorter or the same as parent. Also, the information flow is always from top to bottom or from bottom to top in the hierarchy. This configuration has been found so far to be optimal.

Another alternative is to have a system object as a mediator between the index table object and rolling cache as shown in FIG. 15.

Finally, the index table 6, relation table 2, rolling cache 8, and the address and aggregate files 10, 12 could each be independent objects which could all communicate through a global mediator. The disadvantage is that the communication among all the objects is unnecessarily exposed, particularly as it is not required for each object to communicate with all the other objects.

The description of the overall operations in the previous section does not have any implications on the object containment hierarchy discussed above.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A method of aggregating fact data from a set of fact data records into appropriate aggregate buckets, wherein each of said fact data records is associated with an entry in each of a plurality of dimensions identifying said fact data record, and wherein said aggregate buckets relate to specific values in levels in said plurality of dimensions; said method comprising the steps of:
identifying the required level combinations to which each fact data record will contribute;
identifying the appropriate aggregate bucket associated with each of said required level combinations with which said fact data record is associated;
incorporating data in said fact data record into each of said aggregate buckets; and
repeating said steps for each fact data record.

2. A method for aggregating fact data from a set of fact data records into appropriate aggregate buckets; wherein said fact data records are associated with an entry in each of a plurality of different dimensions identifying said fact data record, and wherein each of said fact data records is associated with one or more aggregates, each of said aggregates corresponding to a level cross product; said method comprising the steps of comprising:
storing a set of level cross products for which aggregates are required;
calculating the number of aggregates associated with each of said level cross products whereby to establish a set of index values required by each level cross product;
storing a level cross product reference index for referencing the associated set of index values;
identifying an aggregate index for a specified aggregate combination from the set of aggregate index values for the associated level cross product;
establishing an overall aggregate index for an aggregate combination using said level cross product index and said aggregate index; and
mapping said overall index onto one or more aggregate buckets associated with said aggregate combination.

3. A method according to claim 2, wherein said aggregate index values associated with a level cross product are equi-spaced values over a range, and wherein the ranges for the aggregate indexes of each of the level cross products do not overlap, and wherein the reference index value associated with each of each of the level products identifies the starting point of the range of aggregate indexes associated with the level cross product.

4. A method of storing data in a memory cache arranged to hold a plurality of data entries identifiable by an index value and a file holding further data entries of the same type as the memory cache; comprising the steps of:
identifying whether or not a certain index has an associated data entry in said cache;
generating a new data entry in said cache for a new item of input data corresponding to said index if said cache does not have an entry for said index, regardless of whether or not said file contains an entry corresponding to said index;
combining data in a data entry in said cache with a new data entry if said data entry has the same index as said new data entry;
transferring data from said data entries in said cache to said file and removing the corresponding entries from said cache.

5. A method according to claim 4 wherein the transferring step comprises transferring the least recently referenced data entries in said cache.

6. A method according to claim 4 wherein the transferring step comprises transferring the least frequently referenced data entries in said cache.

7. A method according to claim 4 wherein the transferring step comprises transferring a plurality of data entries when the number of data entries in said cache exceeds a predetermined value.

8. A method according to claim 4 wherein the transferring step comprises transferring the least frequently and the least recently referenced data entries in said cache.

9. A method according to claim 4 wherein the data entries comprise aggregate buckets corresponding to predefined aggregates or combinations of aggregates.

10. An aggregation engine for placing fact data from a set of fact data records into appropriate aggregate buckets; wherein said fact data records are associated with an entry in each of a plurality of different dimensions identifying said fact data record, and wherein each of said fact data records is associated with one or more aggregates, each of said aggregates corresponding to a level cross product; said aggregation engine comprising:
means for storing a set of level cross products for which aggregates are required;
means for calculating the number of aggregates associated with each of said level cross products whereby to establish a set of aggregate index values required by each level cross product;
means for storing a level cross product reference index for referencing the associated set of aggregate index values;
means for identifying an aggregate index for a specified aggregate combination from the set of index values for the associated level cross product;
means for establishing an overall index for said aggregate combination using said level cross product index, and said aggregate index; and
means for mapping said overall index onto one or more aggregate buckets associated with said aggregate combination.

11. An aggregation engine according to claim 10, wherein said aggregate index values associated with a level cross product are equi-spaced values over a range, and wherein the ranges for the aggregate indexes of each of the level cross products do not overlap, and wherein the reference index value associated with each of each of the level products identifies the starting point of the range of aggregate indexes associated with the level cross product.

12. A system for storing data comprising
a memory cache arranged to hold a plurality of data entries identifiable by an index value,
a file arranged to hold further data entries of the same type as the memory cache;
means for identifying whether or not a certain index has an associated data entry in said cache;
means for generating a new data entry in said cache for a new item of input data corresponding to said index if said cache does not have an entry for said index, regardless of whether or not said file contains an entry corresponding to said index;
means for combining data in a data entry in said cache with a new data entry if said data entry has the same index as said new data entry;
means for transferring data from said data entries in said cache to said file and removing the corresponding entries from said cache.

13. Apparatus according to claim 12 wherein the means for transferring transfers the least recently referenced data entries in said cache.

14. Apparatus according to claim 12 wherein the means for transferring transfers the least frequently referenced data entries in said cache.

15. Apparatus according to claim 12 wherein the means for transferring transfers a plurality of data entries when the number of data entries in said cache exceeds a predetermined value.

16. Apparatus according to claim 12 wherein the means for transferring transfers data the least frequently and the least recently referenced data entries in said cache.

17. Apparatus according to claim 12 wherein the data entries comprise aggregate buckets corresponding to predefined aggregates or combinations of aggregates.
